(19) United States
(12) Patent Application Publication
(10) Pub. No.: US 2020/0284194 A1
(43) Pub. Date: Sep. 10, 2020

(54) PROCESS FOR CONTROLLING OXIDANT FLOWS IN OPERATION OF A POWER GENERATION PLANT

(71) Applicant: 8 RIVERS CAPITAL, LLC, Durham, NC (US)

(72) Inventors: Yasunori IWAI, Yokohama-shi (JP); Masao ITOH, Yokohama-shi (JP); Shinju SUZUKI, Yokohama-shi (JP); Jeremy Eron FETVEDT, Raleigh, NC (US); Rodney John ALLAM, Chippenham (GB)

(21) Appl. No.: 16/825,892

(22) Filed: Mar. 20, 2020

Related U.S. Application Data
(63) Continuation of application No. 14/331,599, filed on Jul. 15, 2014.

(30) Foreign Application Priority Data
Jul. 26, 2013 (JP) 2013-155406

(51) Int. Cl. F02C 7/057; F02C 3/34; F02C 7/08

(52) U.S. Cl. CPC F02C 7/057; Y02E 20/16; F02C 7/08; F02C 3/34

(57) ABSTRACT

A gas turbine facility 10 of an embodiment has a combustor 20 combusting fuel and oxidant, a turbine 28 rotated by combustion gas exhausted from the combustor 20, a heat exchanger 25 cooling the combustion gas from the turbine 28, a pipe 46 guiding a part of the combustion gas to the combustor 20 via the heat exchanger 25, and a pipe 45 exhausting a remaining part of the combustion gas to an outside. Further, the facility has a pipe 40 supplying fuel to the combustor 20, a pipe 41 supplying oxidant to the combustor 20 via the heat exchanger 25, and a pipe 42 branched from the pipe 41, bypassing the heat exchanger 25, and coupled to the pipe 41, so as to introduce the oxidant into the pipe 41.

### CROSS-REFERENCE TO RELATED APPLICATION

This application is based upon and claims the benefit of priority from Japanese Patent Application No. 2013-155406, filed on Jul. 26, 2013; the entire contents of which are incorporated herein by reference.

### FIELD

Embodiments described herein relate generally to a gas turbine facility.

### BACKGROUND

Increasing efficiency of power generation plants is in progress in response to demands for reduction of carbon dioxide, resource conservation, and the like. Specifically, increasing temperature of working fluid of a gas turbine and a steam turbine, employing a combined cycle, and the like are actively in progress. Further, research and development of collection techniques of carbon dioxide are in progress.

FIG. 5 is a system diagram of a conventional gas turbine facility in which a part of carbon dioxide generated in a combustor is circulated as working fluid. As illustrated in FIG. 5, oxygen separated from an air separator (not illustrated) is compressed by a compressor 310, and its flow rate is controlled by a flow rate regulating valve 311. The oxygen which has passed through the flow rate regulating valve 311 is heated by receiving a heat quantity from combustion gas in a heat exchanger 312, and is supplied to a combustor 313.

Fuel is regulated in flow rate by a flow rate regulating valve 314 and is supplied to the combustor 313. This fuel is hydrocarbon. The fuel and oxygen react (combust) in the combustor 313. When the fuel combusts with oxygen, carbon dioxide and water vapor are generated as combustion gas. The flow rates of fuel and oxygen are regulated to be of a stoichiometric mixture ratio in a state that they are completely mixed.

The combustion gas generated in the combustor 313 is introduced into a turbine 315. The combustion gas which performed an expansion work in the turbine 315 passes through the heat exchanger 312 and then further through a heat exchanger 316. When passing through the heat exchanger 316, the water vapor condenses into water. The water passes through a pipe 319 and is discharged to the outside.

The carbon dioxide separated from the water vapor is compressed by a compressor 317. A part of the compressed carbon dioxide is regulated in flow rate by a flow rate regulating valve 318 and is extracted to the outside. The rest of the carbon dioxide is heated in the heat exchanger 312 and supplied to the combustor 313.

Now, the carbon dioxide supplied to the combustor 313 is used to cool wall surfaces of the combustor 313 and dilute the combustion gas. Then, the carbon dioxide is introduced into the combustor 313 and introduced into the turbine 315 together with the combustion gas.

In the system, the carbon dioxide and water generated by the hydrocarbon and oxygen supplied to the combustor 313 are exhausted to the outside of the system. Then, the remaining carbon dioxide circulates through the system.

In a power generating plant, the amount of generated power is often finely regulated depending on demands for electric power. In such cases, the fuel flow rate is finely regulated in a gas turbine. In the above-described conventional gas turbine facility, the fuel flow rate and the oxygen flow rate are regulated to be of the stoichiometric mixture ratio in a state that the both are mixed completely so that fuel and oxygen react (combust) in proper quantities. Accordingly, accompanying increase or decrease of the fuel flow rate, the oxygen flow rate should also be increased or decreased.

In the conventional gas turbine facility illustrated in FIG. 5, the flow rate regulating valve 311 is disposed on an upstream side of the heat exchanger 312. Then, the distance between the flow rate regulating valve 311 and the combustor 313 is large. Depending on the size and disposition layout of the power generating plant, this distance can be a few tens of meters. In this case, when the fuel flow rate changes rapidly, the following ability of the oxygen flow rate worsens since the distance between the combustor 313 and the flow rate regulating valve 311 of oxygen is far. Thus, excess oxygen or excess fuel remains in the system.

FIG. 6 is a diagram illustrating changes in fuel flow rate and oxygen flow rate over time in the conventional gas turbine facility. The fuel flow rate changes by the amount of generated power. To maintain the stoichiometric mixture ratio, it is necessary that the oxygen flow rate changes accompanying the change in fuel flow rate, and the flow rate ratio of fuel and oxygen is maintained constant. However, as illustrated in FIG. 6, the change in oxygen flow rate is slightly late, and the flow rate ratio of fuel and oxygen is not maintained constant.

As described above, in the conventional gas turbine facility, the oxygen flow rates cannot follow the change in fuel flow rate. Accordingly, it has been difficult to maintain the flow rate ratio of fuel and oxygen constant. In particular, when the fuel flow rate changes to an increasing side, excess fuel remains in the combustion gas exhausted from the combustor. Thus, the fuel circulates through the system, resulting in that the fuel is discharged to the outside.

### BRIEF DESCRIPTION OF THE DRAWINGS

FIG. 1 is a system diagram of a gas turbine facility of a first embodiment.

FIG. 2 is a diagram illustrating changes in fuel flow rate and oxygen flow rate over time in the gas turbine facility of the first embodiment.

FIG. 3 is a system diagram of a gas turbine facility of a second embodiment.

FIG. 4 is a system diagram of a gas turbine facility of a third embodiment.

FIG. 5 is a system diagram of a conventional gas turbine facility in which a part of carbon dioxide generated in a combustor is circulated as working fluid.

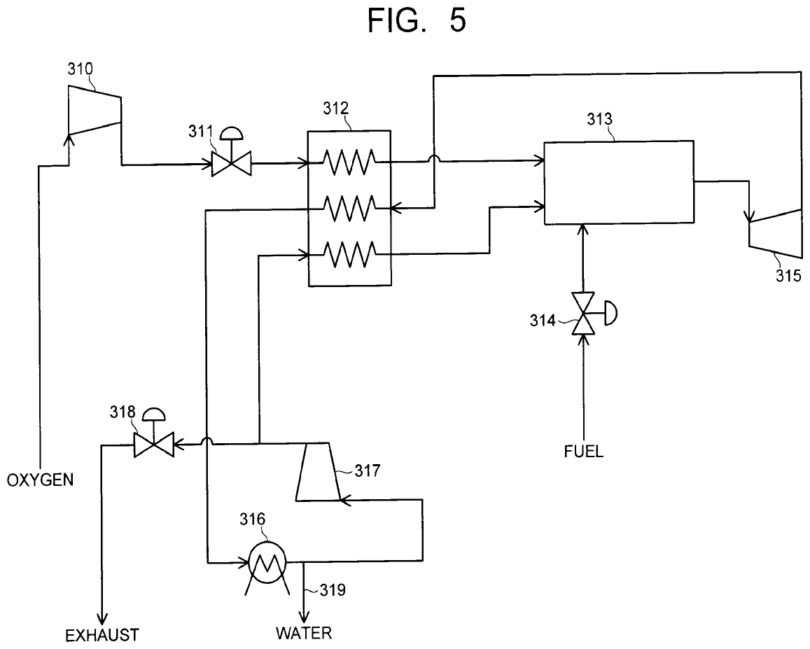

FIG. 6 is a diagram illustrating changes in fuel flow rate and oxygen flow rate over time in the conventional gas turbine facility.

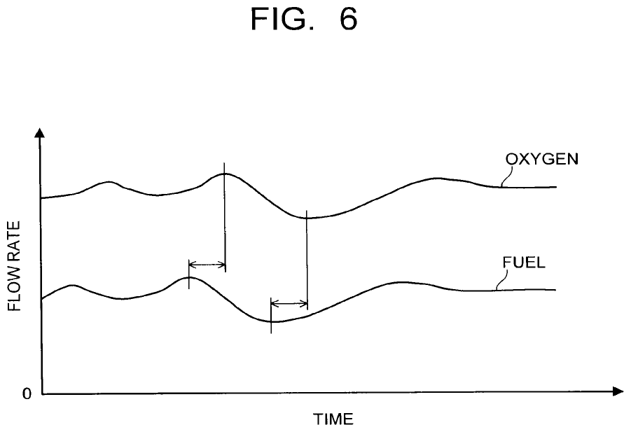

### DETAILED DESCRIPTION

In one embodiment, a gas turbine facility has a combustor combusting fuel and oxidant, a turbine rotated by combustion gas exhausted from the combustor, a heat exchanger cooling the combustion gas exhausted from the turbine, a working fluid supply pipe guiding a part of the combustion gas as working fluid to the combustor via the heat exchanger, and an exhaust pipe exhausting a remaining part of the combustion gas to an outside.

Further, the gas turbine facility has a fuel supply pipe supplying fuel to the combustor, an oxidant supply pipe supplying the oxidant to the combustor via the heat exchanger, and an oxidant bypass supply pipe branched from the oxidant supply pipe, bypassing the heat exchanger, and coupled to the oxidant supply pipe at a position between the heat exchanger and the combustor, so as to introduce the oxidant into the oxidant supply pipe.

Hereinafter, embodiments will be described with reference to drawings.

### First Embodiment

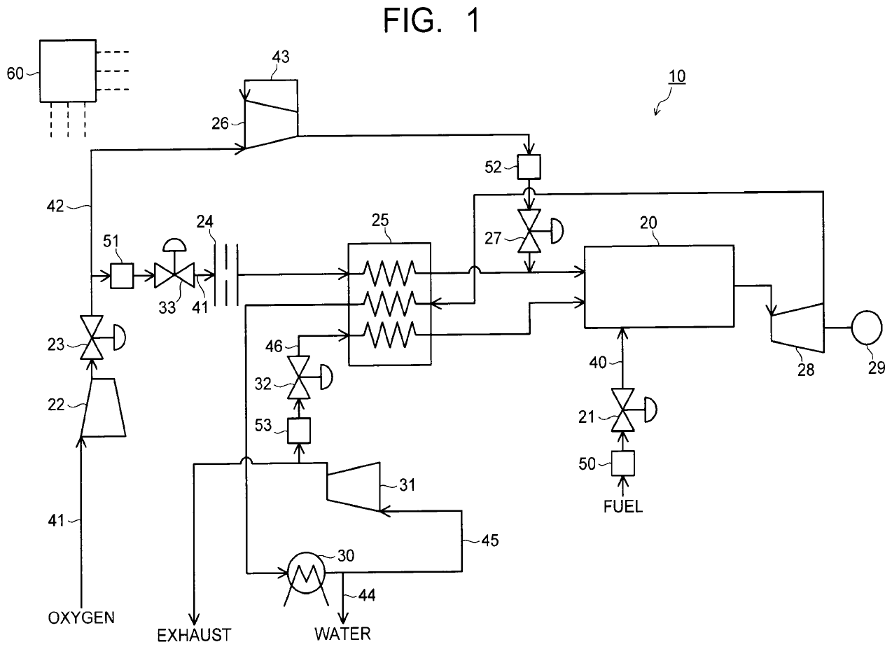

FIG. 1 is a system diagram of a gas turbine facility 10 of a first embodiment. As illustrated in FIG. 1, the gas turbine facility 10 has a combustor 20 combusting fuel and oxidant, and a pipe 40 supplying fuel to this combustor 20. The fuel supplied to the combustor 20 is regulated in flow rate by a flow rate regulating valve 21 interposed in the pipe 40. Note that the pipe 40 functions as a fuel supply pipe. Here, for example, hydrocarbon such as methane or natural gas is used as the fuel, but coal gasification gas fuel containing carbon monoxide and hydrogen and the like can also be used.

The oxidant is separated from the atmosphere by an air separating apparatus (not illustrated) and is compressed by a compressor 22 interposed in a pipe 41. The compressed oxidant is regulated in flow rate by flow rate regulating valves 23, 33 interposed in the pipe 41, passes through a narrowed part 24 such as an orifice and a heat exchanger 25, and is supplied to the combustor 20. Passing through the heat exchanger 25, the oxidant obtains a heat quantity from combustion gas exhausted from a turbine 28, which will be described later, and is heated thereby. Note that the oxidant which passed through the heat exchanger 25 is supplied to the combustor 20 together with oxidant introduced into the pipe 41 from a pipe 42, which will be described later. Here, oxygen is used as the oxidant.

The fuel and the oxidant guided to the combustor 20 are introduced into a combustion area. Then, the fuel and the oxidant occur a combustion reaction to generate combustion gas. Here, in the gas turbine facility 10, it is preferred that no excess oxidant (oxygen) and fuel remain in the combustion gas exhausted from the combustor 20. Accordingly, the flow rates of fuel and oxidant are regulated to be of, for example, a stoichiometric mixture ratio (equivalence ratio 1). Note that the equivalence ratio mentioned here is an equivalence ratio (overall equivalence ratio) assuming that fuel and oxygen are homogeneously mixed.

The gas turbine facility 10 has a pipe 42 which branches from the pipe 41 in downstream of the flow rate regulating valve 23, bypasses the heat exchanger 25, and is coupled to the pipe 41 between the heat exchanger 25 and the combustor 20. In this pipe 42, a flow rate regulating valve 27 regulating the flow rate of oxidant flowing through a compressor 26 and the pipe 42 is interposed. This pipe 42 is provided to introduce the oxidant into the pipe 41 in the vicinity of the combustor 20 corresponding to the amount of change in fuel flow rate when the fuel flow rate changes. Note that the flow rate regulating valve 27 has a certain intermediate opening, and constantly introduces a certain amount of oxidant from the pipe 42 to the pipe 41.

Here, the compressor 26 operates constantly so that the oxidant can be introduced from the pipe 42 into the pipe 41 in the vicinity of the combustor 20 instantly when the fuel flow rate changes to an increasing side. The oxidant more than the flow rate passing through the flow rate regulating valve 27 flows through the pipe 42 on an upstream side of the compressor 26. Then, a part of the oxidant exhausted from an exit of the compressor 26 passes through a pipe 43 and is returned to the entrance of the compressor 26. When the oxidant is circulated from the exit to the entrance of the compressor 26, the oxidant is cooled by cooling means (not illustrated) such as a heat exchanger with water, air, or a different medium.

When the fuel flow rate changes to the increasing side, the flow rate of oxidant introduced from the pipe 42 into the pipe 41 in the vicinity of the combustor 20 is, for example, 20% or less of the flow rate of the entire oxidant. Further, the pipe 41 is provided with the narrowed part 24. Moreover, the pipe 41 passes through the heat exchanger 25. Thus, a passage resistance in the pipe 41 is larger than a passage resistance in the pipe 42. Further, as described above, the flow rate of oxidant flowing through the flow rate regulating valve 27 is smaller than the flow rate entering the compressor 26. Thus, when the flow rate flowing through the flow rate regulating valve 27 increases abruptly, the flow rate flowing through the pipe 43 decreases or becomes zero. From these points, when the oxidant flows from the pipe 42 to the pipe 41 in the vicinity of the combustor 20, the flow rate of oxidant flowing through the pipe 41 passing through the heat exchanger 25 barely changes.

On the other hand, when the fuel flow rate changes to a decreasing side, the flow rate of oxidant flowing through the flow rate regulating valve 27 also decreases. Thus, the flow rate of oxidant passing through the pipe 43 and returns to the entrance of the compressor 26 increases.

The pipe 42 bypasses the heat exchanger 25. Accordingly, the oxidant lower in temperature than the oxidant flowing through the pipe 41 is introduced from the pipe 42 into the pipe 41 in the vicinity of the combustor 20. However, since the flow rate of oxidant introduced from the pipe 42 into the pipe 41 in the vicinity of the combustor 20 is small as described above, its influence on combustibility is small.

Here, the pipe 41 functions as an oxidant supply pipe, the pipe 42 functions as an oxidant bypass supply pipe, and the flow rate regulating valve 27 functions as an oxidant bypass flow rate regulating valve.

The gas turbine facility 10 has a turbine 28 rotated by combustion gas exhausted from the combustor 20. For example, a generator 29 is coupled to this turbine 28. The combustion gas mentioned here exhausted from the combustor 20 contains combustion product, generated by fuel and oxidant, and dry combustion gas (carbon dioxide), which will be described later, supplied to the combustor 20 and exhausted together with the combustion product from the combustor 20.

The combustion gas exhausted from the turbine 28 is cooled by passing through the heat exchanger 25. The combustion gas which passed through the heat exchanger 25 further passes through a heat exchanger 30. By passing through the heat exchanger 30, water vapor contained in the combustion gas is removed, and thereby the combustion gas becomes dry combustion gas. Here, by passing through the heat exchanger 30, the water vapor condenses into water. The water passes through the pipe 44 for example and is discharged to the outside. Note that the heat exchanger 30 functions as a water vapor remover removing water vapor.

Here, as described above, when the flow rates of fuel and oxidant are regulated to be of the stoichiometric mixture ratio (equivalence ratio 1), components of the dry combustion gas are mostly carbon dioxide. Note that the dry combustion gas also includes the case where, for example, a minute amount of carbon monoxide of 0.2% or less is mixed in.

The dry combustion gas is compressed by a compressor 31 interposed in a pipe 45. A part of the compressed dry combustion gas flows into a pipe 46 branched from the pipe 45. Then, the dry combustion gas flowing through the pipe 46 is regulated in flow rate by a flow rate regulating valve 32 interposed in the pipe 46, and is guided to the combustor 20 via the heat exchanger 25. Note that the pipe 46 functions as a working fluid supply pipe and the flow rate regulating valve 32 functions as a working fluid flow rate regulating valve.

The dry combustion gas flowing through the pipe 46 obtains in the heat exchanger 25 a heat quantity from the combustion gas exhausted from the turbine 28 and is heated thereby. The dry combustion gas guided to the combustor 20 cools, for example, a combustor liner and is guided into a downstream side of a combustion area in the combustor liner via a dilution hole or the like. This dry combustion gas rotates the turbine 28 together with the combustion gas generated by combustion, and hence functions as working fluid.

On the other hand, a remaining part of the dry combustion gas compressed by the compressor 31 is exhausted to the outside from an end of the pipe 45. The end of the pipe 45 exhausting the dry combustion gas to the outside also functions as an exhaust pipe.

Further, the gas turbine facility 10 has a flow rate detecting unit 50 detecting the flow rate of fuel flowing through the pipe 40, a flow rate detecting unit 51 detecting the flow rate of oxidant flowing through the pipe 41, a flow rate detecting unit 52 detecting the flow rate of oxidant flowing through the pipe 42, and a flow rate detecting unit 53 detecting the flow rate of dry combustion gas (working fluid) flowing through the pipe 46. Each flow rate detecting unit is constituted of, for example, a flowmeter such as a venturi tube or a Coriolis flowmeter.

Here, the flow rate detecting unit 50 functions as a fuel flow rate detecting unit, the flow rate detecting unit 51 functions as an oxidant flow rate detecting unit, the flow rate detecting unit 52 functions as an oxidant bypass flow rate detecting unit, and the flow rate detecting unit 53 functions as a working fluid flow rate detecting unit.

The gas turbine facility 10 has a control unit 60 which controls openings of the respective flow rate regulating valves 21, 23, 27, 32, 33 based on, for example, detection signals from the respective flow rate detecting units 50, 51, 52, 53. This control unit 60 mainly has, for example, an arithmetic unit (CPU), a storage unit such as a read only memory (ROM) and a random access memory (RAM), an input/output unit, and so on. The CPU executes various arithmetic operations using, for example, programs, data, and the like stored in the storage unit.

The input/output unit inputs an electrical signal from an outside device or outputs an electrical signal to an outside device. Specifically, the input/output unit is connected to, for example, the respective flow rate detecting units 50, 51, 52, 53 and the respective flow rate regulating valves 21, 23, 27, 32, 33, and so on in a manner capable of inputting/outputting various signals. Processing executed by this control unit 60 is realized by, for example, a computer apparatus or the like.

Next, operations related to flow rate regulation of the fuel, the oxidant (oxygen), and the dry combustion gas (carbon dioxide) as the working fluid to be supplied to the combustor 20 will be described with reference to FIG. 1.

While the gas turbine facility 10 is operated, an output signal from the flow rate detecting unit 50 is inputted to the control unit 60 via the input/output unit. Based on the inputted output signal, it is judged whether the fuel flow rate has changed or not.

When it is judged that the fuel flow rate has not changed, the control unit 60 repeats the judgment of whether the fuel flow rate has changed or not based on the inputted output signal.

When it is judged that the fuel flow rate has changed to the increasing side, output signals from the flow rate detecting unit 50, the flow rate detecting unit 51, and the flow rate detecting unit 52 are inputted to the control unit 60 via the input/output unit. Then the control unit 60 calculates an equivalence ratio from the flow rates of fuel and oxygen in the arithmetic unit by using programs, data, and the like stored in the storage unit.

When the calculated equivalence ratio is 1, the judgment of whether the fuel flow rate has changed or not is repeated again.

When the calculated equivalence ratio exceeds 1, the control unit 60 calculates an oxygen flow rate to be introduced from the pipe 42 into the pipe 41 to make the equivalence ratio be 1 in the arithmetic unit by using output signals from the flow rate detecting unit 50, the flow rate detecting unit 51, and the flow rate detecting unit 52 and programs, data, and the like stored in the storage unit. The control unit 60 outputs an output signal for regulating a valve opening from the input/output unit to the flow rate regulating valve 27 so that the calculated oxygen flow rate can be introduced into the pipe 41. Note that in this case, the flow rate regulating valve 27 is regulated in a direction to increase the valve opening.

On the other hand, when it is judged that the fuel flow rate has changed to the decreasing side, output signals from the flow rate detecting unit 50, the flow rate detecting unit 51, and the flow rate detecting unit 52 are inputted to the control unit 60 via the input/output unit. Then, the control unit 60 calculates the equivalence ratio from the flow rates of fuel and oxygen in the arithmetic unit by using programs, data, and the like stored in the storage unit.

When the calculated equivalence ratio is 1, the judgment of whether the fuel flow rate has changed or not is repeated again.

When the calculated equivalence ratio is smaller than 1, the control unit 60 calculates the oxygen flow rate to be introduced from the pipe 42 into the pipe 41 to make the equivalence ratio be 1 in the arithmetic unit by using output signals from the flow rate detecting unit 50, the flow rate detecting unit 51, and the flow rate detecting unit 52 and programs, data, and the like stored in the storage unit. The control unit 60 outputs an output signal for regulating a valve opening from the input/output unit to the flow rate regulating valve 27 so that the calculated oxygen flow rate can be introduced into the pipe 41. Note that in this case, the flow rate regulating valve 27 is regulated in a direction to decrease the valve opening.

Subsequently, in the arithmetic unit of the control unit 60, the flow rate of dry combustion gas (carbon dioxide) supplied to the combustor 20 as working fluid is calculated based on output signals from the flow rate detecting unit 50 and the flow rate detecting unit 53 which are inputted from the input/output unit. Note that the flow rate of dry combustion gas (carbon dioxide) can also be calculated based on output signals from the flow rate detecting unit 51, the flow rate detecting unit 52, and the flow rate detecting unit 53.

Here, the flow rate of dry combustion gas (carbon dioxide) supplied as working fluid is determined based on, for example, the flow rate of fuel supplied to the combustor 20. For example, the amount equivalent to the generated amount of carbon dioxide generated by combusting fuel in the combustor 20 is exhausted to the outside via the end of the pipe 45 functioning as an exhaust pipe. For example, when the flow rate of fuel is constant, the flow rate of carbon dioxide supplied to the entire combustor 20 is controlled to be constant. That is, when the flow rate of fuel is constant, carbon dioxide circulates at a constant flow rate in the system.

Next, the control unit 60 outputs an output signal for regulating the valve opening from the input/output unit to the flow rate regulating valve 32 so that the calculated flow rate of carbon dioxide flows into the pipe 46 based on an output signal from the flow rate detecting unit 53 which is inputted from the input/output unit.

By controlling as described above, the fuel, the oxidant, and the dry combustion gas as working fluid are supplied to the combustor 20. By performing such control, for example, even when the fuel flow rate changes to the increasing side, the flow rate of oxidant introduced from the pipe 42 to the pipe 41 is regulated instantly.

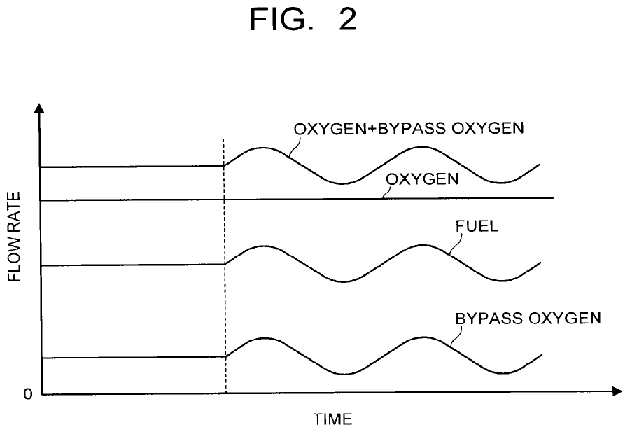

Now, FIG. 2 is a diagram illustrating changes in fuel flow rate and oxygen flow rate over time in the gas turbine facility 10 of the first embodiment. As illustrated in FIG. 2, for example, when the fuel flow rate changes, the flow rate regulating valve 27 is controlled to regulate the flow rate of oxygen (denoted as bypass oxygen in FIG. 2) introduced from the pipe 42 into the pipe 41 corresponding to the amount of change in fuel flow rate. Note that the flow rate of oxygen passing through the narrowed part 24 and the heat exchanger 25 and flowing through the pipe 41 is maintained constant even after the valve opening of the flow rate regulating valve 27 is regulated.

By regulating the bypass oxygen flow rate, the oxygen flow rate changes in a manner to follow with almost no time delay from the change in fuel flow rate as illustrated in FIG. 2. Accordingly, the flow rate ratio of fuel and oxygen supplied to the combustor 20 is maintained constant, and for example, the stoichiometric mixture ratio (equivalence ratio 1) is maintained.

As described above, in the gas turbine facility 10 of the first embodiment, by providing the pipe 42, even when the flow rate regulating valve 23 regulating the flow rate of oxidant is provided at a separate distance from the combustor 20 for example, the oxidant corresponding to the amount of change in fuel flow rate is introduced instantly into the pipe 41 in the vicinity of the combustor 20 when the fuel flow rate changes. Thus, when the fuel flow rate changes, the flow rates of fuel and oxidant are regulated instantly to the stoichiometric mixture ratio (equivalence ratio 1).

Further, since the pipe 42 bypasses the heat exchanger 25, the oxidant at high temperature will not flow through the pipe 42. Accordingly, it is not necessary to use an expensive valve for high temperature as the flow rate regulating valve 27 interposed in the pipe 42.

### Second Embodiment

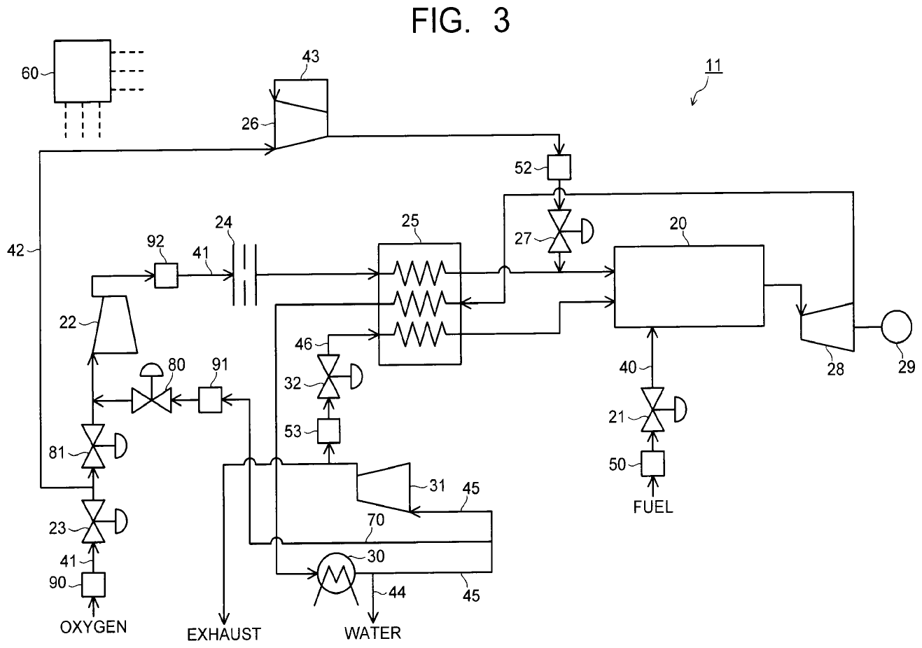

FIG. 3 is a system diagram of a gas turbine facility 11 of a second embodiment. Note that the same components as those of the gas turbine facility 10 of the first embodiment are designated by the same reference numerals, and overlapping descriptions are omitted or simplified.

The gas turbine facility 11 of the second embodiment differs from the gas turbine facility 10 of the first embodiment in a structure having a combustion gas supply pipe. Here, this different structure will be mainly described.

As illustrated in FIG. 3, the combustion gas exhausted from the turbine 28 passes through the heat exchanger 30 where water vapor contained in the combustion gas is removed, and thereby becomes dry combustion gas (carbon dioxide). A part of the dry combustion gas flows into a pipe 70 branched from the pipe 45 in which the dry combustion gas flows. Then, the dry combustion gas which flowed into the pipe 70 is regulated in flow rate by a flow rate regulating valve 80 interposed in the pipe 70, and is introduced to a downstream side of the position on the pipe 41 where the pipe 42 is branched. Accordingly, mixed gas constituted of the oxidant (oxygen) and the dry combustion gas flows through the pipe 41 on a downstream side of the position where the pipe 70 is coupled. Here, the pipe 70 functions as a combustion gas supply pipe.

The dry combustion gas introduced into the pipe 41 from the pipe 70 mixes with the oxidant regulated in flow rate by flow rate regulating valves 23, 81, and is compressed by the compressor 22 interposed in the pipe 41. The compressed mixed gas passes through the narrowed part 24 and the heat exchanger 25 and is supplied to the combustor 20. Passing through the heat exchanger 25, the mixed gas obtains a heat quantity from the combustion gas exhausted from the turbine 28 and is heated thereby. Note that the mixed gas which passed through the heat exchanger 25 is supplied to the combustor 20 together with the oxidant introduced from the pipe 42 into the pipe 41.

The fuel, the oxidant, and the mixed gas introduced into the combustor 20 are introduced into the combustion area. Then, the fuel and the oxidant occur a combustion reaction to generate combustion gas. Here, in the gas turbine facility 11, it is preferred that no excess oxidant (oxygen) and fuel remain in the combustion gas exhausted from the combustor 20. Accordingly, the flow rates of fuel and oxidant are regulated to be of, for example, the stoichiometric mixture ratio (equivalence ratio 1).

Here, the mixture ratio of the oxidant and the dry combustion gas (carbon dioxide) in the mixed gas is maintained constant. Further, from a viewpoint of stabilizing combustibility in the combustor 20, for example, the ratio of oxidant to the mixed gas is preferably set in the range of 15 to 40 mass %. Further, the ratio of oxidant to the mixed gas is more preferably 20 to 30 mass %.

Note that in the dry combustion gas, a part other than that flowing through the pipe 70 is compressed by the compressor 31. A part of the compressed dry combustion gas flows through the pipe 46, and the rest is exhausted to the outside from the end of the pipe 45.

The gas turbine facility 11 has a flow rate detecting unit 90 detecting the flow rate of oxidant flowing through the pipe 41 on an upstream side of the position where the pipe 42 is branched, a flow rate detecting unit 91 detecting the flow rate of dry combustion gas introduced into the pipe 41, and a flow rate detecting unit 92 detecting the flow rate of mixed gas flowing through the pipe 41. Each flow rate detecting unit is constituted of, for example, a flowmeter such as a venturi tube or a Coriolis flowmeter.

Here, the flow rate detecting unit 90 functions as an oxidant flow rate detecting unit, the flow rate detecting unit 91 functions as a combustion gas flow rate detecting unit, and the flow rate detecting unit 92 functions as a mixed gas flow rate detecting unit.

The input/output unit of the control unit 60 is further connected to, for example, the respective flow rate detecting units 90, 91, 92, the respective flow rate regulating valves 80, 81, and so on other than those illustrated in the first embodiment in a manner capable of inputting/outputting various signals.

Next, operations related to flow rate regulation of the mixed gas constituted of oxidant (oxygen) and dry combustion gas (carbon dioxide) supplied to the combustor 20, the oxidant flowing through the pipe 42, the fuel, and the dry combustion gas (carbon dioxide) as working fluid will be described with reference to FIG. 3.

While the gas turbine facility 11 is operated, an output signal from the flow rate detecting unit 50 is inputted to the control unit 60 via the input/output unit. It is judged whether the fuel flow rate has changed or not, based on the inputted output signal.

When it is judged that the fuel flow rate has not changed, the control unit 60 repeats the judgment of whether the fuel flow rate has changed to the increasing side or not based on the inputted output signal.

When it is judged that the fuel flow rate has changed to the increasing side, output signals from the flow rate detecting unit 50 and the flow rate detecting unit 90 are inputted to the control unit 60 via the input/output unit. Then the control unit 60 calculates the equivalence ratio from the flow rates of fuel and oxygen in the arithmetic unit by using programs, data, and the like stored in the storage unit.

When the calculated equivalence ratio is 1, the judgment of whether the fuel flow rate has changed or not is repeated again.

When the calculated equivalence ratio exceeds 1, the control unit 60 calculates an oxygen flow rate to be introduced from the pipe 42 into the pipe 41 to make the equivalence ratio be 1 in the arithmetic unit by using output signals from the flow rate detecting unit 50, the flow rate detecting unit 52, the flow rate detecting unit 91, and the flow rate detecting unit 92 and programs, data, and the like stored in the storage unit.

Then, the control unit 60 outputs an output signal for regulating a valve opening from the input/output unit to the flow rate regulating valve 27 so that the calculated oxygen flow rate can be introduced into the pipe 41. Note that in this case, the flow rate regulating valve 27 is regulated in the direction to increase the valve opening. At this time, the oxygen flow rate introduced from the pipe 42 into the pipe 41 is small, and thus its influence on combustibility is small.

On the other hand, when it is judged that the fuel flow rate has changed to the decreasing side, output signals from the flow rate detecting unit 50 and the flow rate detecting unit 90 are inputted to the control unit 60 via the input/output unit. Then, the control unit 60 calculates the equivalence ratio from the flow rates of fuel and oxygen in the arithmetic unit by using programs, data, and the like stored in the storage unit.

When the calculated equivalence ratio is 1, the judgment of whether the fuel flow rate has changed or not is repeated again.

When the calculated equivalence ratio is smaller than 1, the control unit 60 calculates the oxygen flow rate to be introduced from the pipe 42 into the pipe 41 to make the equivalence ratio be 1 in the arithmetic unit by using output signals from the flow rate detecting unit 50, the flow rate detecting unit 52, the flow rate detecting unit 91, and the flow rate detecting unit 92 and programs, data, and the like stored in the storage unit.

Then, the control unit 60 outputs an output signal for regulating a valve opening from the input/output unit to the flow rate regulating valve 27 so that the calculated oxygen flow rate can be introduced into the pipe 41. Note that in this case, the flow rate regulating valve 27 is regulated in the direction to decrease the valve opening.

Note that when there is no change in fuel flow rate, the flow rate regulating valve 27 is in a state opened by a certain opening.

Subsequently, in the arithmetic unit of the control unit 60, the flow rate of dry combustion gas (carbon dioxide) supplied to the combustor 20 as working fluid is calculated based on output signals from the flow rate detecting unit 50, the flow rate detecting unit 53, and the flow rate detecting unit 91 which are inputted from the input/output unit.

Here, the flow rate of dry combustion gas (carbon dioxide) supplied as working fluid is determined based on, for example, the flow rate of fuel supplied to the combustor 20. For example, the amount equivalent to the generated amount of carbon dioxide generated by combusting fuel in the combustor 20 is exhausted to the outside via the end of the pipe 45 functioning as an exhaust pipe. For example, when the flow rate of fuel is constant, the flow rate of carbon dioxide supplied to the entire combustor 20 is controlled to be constant. That is, when the flow rate of fuel is constant, carbon dioxide circulates at a constant flow rate in the system.

Next, the control unit 60 outputs an output signal for regulating the valve opening from the input/output unit to the flow rate regulating valve 32 so that the calculated flow rate of carbon dioxide flows into the pipe 46, based on an output signal from the flow rate detecting unit 53 which is inputted from the input/output unit.

By controlling as described above, the mixed gas, the oxidant, the fuel, and the dry combustion gas as working fluid are supplied to the combustor 20. By performing such control, for example, even when the fuel flow rate changes to the increasing side, the flow rate of oxidant introduced from the pipe 42 to the pipe 41 can be regulated instantly.

Note that, although not illustrated, changes in fuel flow rate and oxygen flow rate over time in the gas turbine facility 11 of the second embodiment when the fuel flow rate changes, change similarly to the case of the gas turbine facility 10 of the first embodiment illustrated in FIG. 2. That is, by regulating the bypass oxygen flow rate, the oxygen flow rate changes in a manner to follow with almost no time delay from the change in fuel flow rate. Accordingly, the flow rate ratio of fuel and oxygen supplied to the combustor 20 is maintained constant, and for example, the stoichiometric mixture ratio (equivalence ratio 1) is maintained.

As described above, in the gas turbine facility 11 of the second embodiment, by providing the pipe 42, even when the flow rate regulating valve 23 regulating the flow rate of oxidant is provided at a separate distance from the combustor 20 for example, the oxidant corresponding to the amount of change in fuel flow rate is introduced instantly into the pipe 41 in the vicinity of the combustor 20 when the fuel flow rate changes. Thus, when the fuel flow rate changes to the increasing side, the flow rates of fuel and oxidant are regulated instantly to the stoichiometric mixture ratio (equivalence ratio 1).

Further, since the pipe 42 bypasses the heat exchanger 25, oxidant at high temperature will not flow through the pipe 42. Accordingly, it is not necessary to use an expensive valve for high temperature as the flow rate regulating valve 27 interposed in the pipe 42.

### Third Embodiment

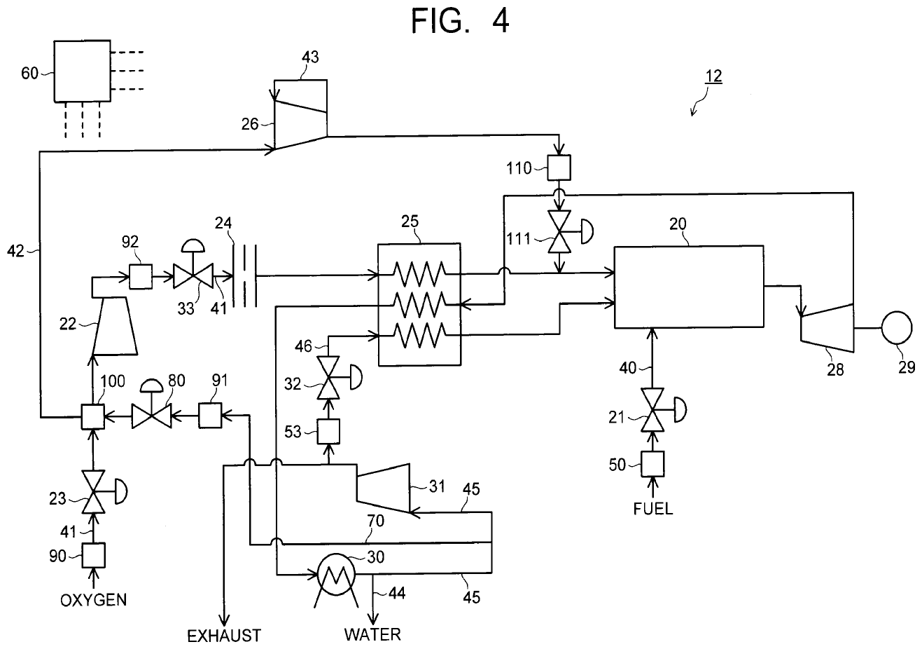

FIG. 4 is a system diagram of a gas turbine facility 12 of a third embodiment. Note that the same components as those of the gas turbine facility 10 of the first embodiment or the gas turbine facility 11 of the second embodiment are designated by the same reference numerals, and overlapping descriptions are omitted or simplified.

The gas turbine facility 12 of the third embodiment differs from the gas turbine facility 10 of the first embodiment in a structure having a combustion gas supply pipe and the structure of the pipe 42. Here, this different structure will be mainly described.

As illustrated in FIG. 4, the combustion gas exhausted from the turbine 28 passes through the heat exchanger 30 where water vapor contained in the combustion gas is removed, and thereby becomes dry combustion gas (carbon dioxide). A part of the dry combustion gas flows into a pipe 70 branched from the pipe 45 in which the dry combustion gas flows. Then, the dry combustion gas which flowed into the pipe 70 is regulated in flow rate by a flow rate regulating valve 80 interposed in the pipe 70, and is introduced into a mixing part 100 interposed in the pipe 41. This mixing part 100 is, for example, a space in which a flow path cross-sectional area of the pipe 41 is enlarged. In this space, mixing of the oxidant (oxygen) and the dry combustion gas (carbon dioxide) is facilitated.

Accordingly, in the pipe 41 on a downstream side of the mixing part 100, mixed gas constituted of oxidant regulated in flow rate by the flow rate regulating valve 23 and dry combustion gas flows. Here, the pipe 70 functions as a combustion gas supply pipe.

The mixed gas flowing out from the mixing part 100 and flowing through the pipe 41 is compressed by the compressor 22 interposed in the pipe 41. The compressed mixed gas passes through the narrowed part 24 and the heat exchanger 25 and is supplied to the combustor 20. Passing through the heat exchanger 25, the mixed gas obtains a heat quantity from the combustion gas exhausted from the turbine 28 and is heated thereby. Note that the mixed gas which passed through the heat exchanger 25 is supplied to the combustor 20 together with the mixed gas introduced from the pipe 42 into the pipe 41.

The fuel and the mixed gas introduced into the combustor 20 are introduced into the combustion area. Then, the fuel and the oxidant occur a combustion reaction to generate combustion gas. Here, in the gas turbine facility 12, it is preferred that no excess oxidant (oxygen) and fuel remain in the combustion gas exhausted from the combustor 20. Accordingly, the flow rates of fuel and oxidant are regulated to be of, for example, the stoichiometric mixture ratio (equivalence ratio 1). Note that the ratio of oxidant to mixed gas is as described in the second embodiment.

The pipe 42 branched from the mixing part 100 of the pipe 41 bypasses the heat exchanger 25 and is structured to be capable of introducing the mixed gas into the pipe 41 between the heat exchanger 25 and the combustor 20. In the pipe 42, a flow rate regulating valve 111 regulating the flow rate of mixed gas flowing through the compressor 26 and the pipe 42 is interposed. This pipe 42 is provided for introducing the mixed gas into the pipe 41 corresponding to the amount of change in fuel flow rate when the fuel flow rate changes. Note that the flow rate regulating valve 111 normally opens with a certain intermediate opening, and constantly introduces the mixed gas from the pipe 42 into the pipe 41 in the vicinity of the combustor 20.

Here, the compressor 26 operates constantly so that the mixed gas can be introduced from the pipe 42 into the pipe 41 instantly when the fuel flow rate changes. Then, by the amount of a change in the flow rate passing through the flow rate regulating valve 111, the flow rate passing through the pipe 43 which a part of mixed gas exhausted from the exit of the compressor 26 passes through changes also.

When the mixed gas is circulated from the exit to the entrance of the compressor 26, the mixed gas is cooled by cooling means (not illustrated) such as a heat exchanger with water, air, or a different medium.

When the fuel flow rate changes to the increasing side, the flow rate of mixed gas introduced from the pipe 42 into the pipe 41 is, for example, 20% or less of the flow rate of the entire mixed gas. Further, the pipe 41 is provided with the narrowed part 24. Moreover, the pipe 41 passes through the heat exchanger 25. Thus, the passage resistance in the pipe 41 is larger than the passage resistance in the pipe 42. From these points, when the mixed gas flows through the pipe 42, the flow rate of mixed gas flowing through the pipe 41 barely changes.

Further, the pipe 42 bypasses the heat exchanger 25. Accordingly, the mixed gas lower in temperature than the mixed gas flowing through the pipe 41 is introduced from the pipe 42 into the pipe 41. However, since the flow rate of mixed gas introduced from the pipe 42 into the pipe 41 is small as described above, its influence on combustibility is small.

Here, the pipe 41 functions as an oxidant supply pipe, the pipe 42 functions as an oxidant bypass supply pipe, and the flow rate regulating valve 111 functions as a mixed gas bypass flow rate regulating valve.

Note that in the dry combustion gas, a part other than that flowing through the pipe 70 is compressed by the compressor 31. A part of the compressed dry combustion gas flows through the pipe 46, and the rest is exhausted to the outside from the end of the pipe 45.

The gas turbine facility 12 has a flow rate detecting unit 90 detecting the flow rate of oxidant flowing through the pipe 41 on an upstream side of the position where the mixing part 100 is provided, a flow rate detecting unit 91 detecting the flow rate of dry combustion gas introduced into the mixing part 100, a flow rate detecting unit 92 detecting the flow rate of mixed gas flowing through the pipe 41, and a flow rate detecting unit 110 detecting the flow rate of mixed gas flowing through the pipe 42. Each flow rate detecting unit is constituted of, for example, a flowmeter such as a venturi tube or a Coriolis flowmeter.

Here, the flow rate detecting unit 90 functions as an oxidant flow rate detecting unit, the flow rate detecting unit 91 functions as a combustion gas flow rate detecting unit, the flow rate detecting unit 92 functions as a mixed gas flow rate detecting unit, and the flow rate detecting unit 110 functions as a mixed gas bypass flow rate detecting unit.

The input/output unit of the control unit 60 is further connected to, for example, the respective flow rate detecting units 90, 91, 92, 110, the respective flow rate regulating valves 33, 80, 111, and so on other than those illustrated in the first embodiment in a manner capable of inputting/outputting various signals.

Next, operations related to flow rate regulation of the mixed gas constituted of oxidant (oxygen) and dry combustion gas (carbon dioxide) supplied to the combustor 20, the mixed gas flowing through the pipe 42, the fuel, and the dry combustion gas (carbon dioxide) as working fluid will be described with reference to FIG. 4.

While the gas turbine facility 12 is operated, an output signal from the flow rate detecting unit 50 is inputted to the control unit 60 via the input/output unit. The control unit 60 judges whether the fuel flow rate has changed or not, based on the inputted output signal.

When it is judged that the fuel flow rate has not changed, the control unit 60 repeats the judgment of whether the fuel flow rate has changed or not based on the inputted output signal.

When it is judged that the fuel flow rate has changed to the increasing side, output signals from the flow rate detecting unit 50 and the flow rate detecting unit 90 are inputted to the control unit 60 via the input/output unit. Then the control unit 60 calculates the equivalence ratio from the flow rates of fuel and oxygen in the arithmetic unit by using programs, data, and the like stored in the storage unit.

When the calculated equivalence ratio is 1, the judgment of whether the fuel flow rate has changed or not is repeated again.

When the calculated equivalence ratio exceeds 1, the control unit 60 calculates a mixed gas flow rate to be introduced from the pipe 42 into the pipe 41 in the vicinity of the combustor 20 to make the equivalence ratio be 1 in the arithmetic unit by using output signals from the flow rate detecting unit 50, the flow rate detecting unit 90, the flow rate detecting unit 91, the flow rate detecting unit 92, and the flow rate detecting unit 110 and programs, data, and the like stored in the storage unit. Note that the mixture ratio of oxidant (oxygen) and dry combustion gas (carbon dioxide) in the mixed gas formed in the mixing part 100 is constant.

Then, the control unit 60 outputs an output signal for regulating a valve opening from the input/output unit to the flow rate regulating valve 111 so that the calculated mixed gas flow rate can be introduced into the pipe 41. Note that in this case, the flow rate regulating valve 111 is regulated in the direction to increase the valve opening.

On the other hand, when it is judged that the fuel flow rate has changed to the decreasing side, output signals from the flow rate detecting unit 50 and the flow rate detecting unit 90 are inputted to the control unit 60 via the input/output unit. Then, the control unit 60 calculates the equivalence ratio from the flow rates of fuel and oxygen in the arithmetic unit by using programs, data, and the like stored in the storage unit.

When the calculated equivalence ratio is 1, the judgment of whether the fuel flow rate has changed or not is repeated again.

When the calculated equivalence ratio is smaller than 1, the control unit 60 calculates the mixed gas flow rate to be introduced from the pipe 42 into the pipe 41 in the vicinity of the combustor 20 to make the equivalence ratio be 1 in the arithmetic unit by using output signals from the flow rate detecting unit 50, the flow rate detecting unit 90, the flow rate detecting unit 91, the flow rate detecting unit 92, and the flow rate detecting unit 110 and programs, data, and the like stored in the storage unit.

Then, the control unit 60 outputs an output signal for regulating a valve opening from the input/output unit to the flow rate regulating valve 111 so that the calculated mixed gas flow rate can be introduced into the pipe 41. Note that in this case, the flow rate regulating valve 111 is regulated in the direction to decrease the valve opening.

Note that when there is no change in fuel flow rate, the flow rate regulating valve 111 is in a state opened by a certain opening.

Subsequently, in the arithmetic unit of the control unit 60, the flow rate of dry combustion gas (carbon dioxide) supplied to the combustor 20 as working fluid is calculated based on output signals from the flow rate detecting unit 50, the flow rate detecting unit 53, and the flow rate detecting unit 91 which are inputted from the input/output unit.

Here, the flow rate of dry combustion gas (carbon dioxide) supplied as working fluid is determined based on, for example, the flow rate of fuel supplied to the combustor 20. For example, the amount equivalent to the generated amount of carbon dioxide generated by combusting fuel in the combustor 20 is exhausted to the outside via the end of the pipe 45 functioning as an exhaust pipe. For example, when the flow rate of fuel is constant, the flow rate of carbon dioxide supplied to the entire combustor 20 is controlled to be constant. That is, when the flow rate of fuel is constant, carbon dioxide circulates at a constant flow rate in the system.

Next, the control unit 60 outputs an output signal for regulating the valve opening from the input/output unit to the flow rate regulating valve 32 so that the calculated flow rate of carbon dioxide flows into the pipe 46, based on an output signal from the flow rate detecting unit 53 which is inputted from the input/output unit.

By controlling as described above, the mixed gas flowing through the pipes 41, 42, the fuel, and the dry combustion gas as working fluid are supplied to the combustor 20. By performing such control, for example, even when the fuel flow rate changes to the increasing side, the flow rate of mixed gas introduced from the pipe 42 into the pipe 41 can be regulated instantly.

Note that, although not illustrated, changes in fuel flow rate and oxygen flow rate over time in the gas turbine facility 12 of the third embodiment when the fuel flow rate changes, change similarly to the case of the gas turbine facility 10 of the first embodiment illustrated in FIG. 2. That is, by regulating the flow rate of mixed gas flowing through the pipe 42, the oxygen flow rate changes in a manner to follow with almost no time delay from the change in fuel flow rate. Accordingly, the flow rate ratio of fuel and oxygen supplied to the combustor 20 is maintained constant, and for example, the stoichiometric mixture ratio (equivalence ratio 1) is maintained.

As described above, in the gas turbine facility 12 of the third embodiment, by providing the pipe 42, even when the flow rate regulating valve 23 regulating the flow rate of oxidant is provided at a separate distance from the combustor 20 for example, the mixed gas containing the oxidant corresponding to the amount of change in fuel flow rate is introduced instantly into the pipe 41 in the vicinity of the combustor 20 when the fuel flow rate changes. Thus, when the fuel flow rate changes, the flow rates of fuel and oxidant are regulated instantly to the stoichiometric mixture ratio (equivalence ratio 1).

Further, since the pipe 42 bypasses the heat exchanger 25, mixed gas at high temperature will not flow through the pipe 42. Accordingly, it is not necessary to use an expensive valve for high temperature as the flow rate regulating valve 111 interposed in the pipe 42.

Note that in the above-described embodiment, an example is presented in which hydrocarbon is used as fuel and oxygen is used as oxidant, but hydrogen may be used as fuel and oxygen may be used as oxidant. In this case, the heat exchanger 30 and the pipe 44 become unnecessary. Further, in this case, a branching part of the pipe 46 branching from the pipe 45 may be on an upstream side of the compressor 31. Then, the compressor 31 may be interposed on an upstream side of the flow rate detecting unit 53 of the pipe 46.

In the embodiment as described above, the oxidant flow rate follows changes in fuel flow rate appropriately, and it is possible to maintain the flow rate ratio of fuel and oxidant constantly.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1.-11. (canceled)

12. A process for operation of a power generation plant, the process comprising:
providing a fuel stream to a combustor through a fuel supply pipe including a fuel flow rate detecting unit configured to output a fuel flow rate signal to a controller and including a fuel flow regulating valve;
providing a carbon dioxide stream to the combustor through a carbon dioxide supply pipe including a carbon dioxide flow rate detecting unit configured to output a carbon dioxide flow rate signal to the controller and including a carbon dioxide flow regulating valve;
providing a first portion of an oxidant stream to the combustor through an oxidant supply pipe including an oxidant flow rate detecting unit configured to output an oxidant flow rate signal to the controller and including an oxidant flow regulating valve;
providing a second portion of the oxidant stream through a by-pass oxidant supply pipe including a by-pass oxidant flow rate detecting unit configured to output a by-pass oxidant flow rate signal to the controller and including a by-pass oxidant flow regulating valve, the by-pass oxidant supply pipe being coupled to the oxidant supply pipe upstream from the combustor;
combusting fuel from the fuel stream with oxygen from the oxidant stream in the combustor in the presence of the carbon dioxide from the carbon dioxide stream to form a combustion exhaust gas;
passing the combustion exhaust gas through a turbine to generate power and form a turbine exhaust stream; and
regulating, with the controller, an opening of one or more of the fuel flow regulating valve, the carbon dioxide flow regulating valve, the oxidant flow regulating valve, and the by-pass oxidant flow regulating valve based upon calculations performed by the controller using one or more of the fuel flow rate signal, the carbon dioxide flow rate signal, the oxidant flow rate signal, and the by-pass oxidant flow rate signal.

13. The process of claim 12, wherein the controller is configured to repeatedly receive the fuel flow rate signal from the fuel flow rate detecting unit and determine whether or not a fuel flow rate in the fuel supply pipe has changed.

14. The process of claim 13, wherein when the controller determines that the fuel flow rate in the fuel supply pipe has increased, the controller is configured to utilize the fuel flow rate signal from the fuel flow rate detecting unit, the oxidant flow rate signal from the oxidant flow rate detecting unit, and the by-pass oxidant flow rate signal from the by-pass oxidant flow rate detecting unit to calculate an equivalence ratio of fuel flow through the fuel supply pipe to total oxidant flow through both of the oxidant supply pipe and the by-pass oxidant supply pipe.

15. The process of claim 14, wherein when the equivalence ratio of the fuel flow through the fuel supply pipe to total oxidant flow through both of the oxidant supply pipe and the by-pass oxidant supply pipe exceeds a defined value, the controller is configured to provide an output signal that causes the by-pass oxidant valve to increase an amount of oxidant that is delivered through the by-pass oxidant supply pipe, and when the equivalence ratio of the fuel flow through the fuel supply pipe to total oxidant flow through both of the oxidant supply pipe and the by-pass oxidant supply pipe is less than the defined value, the controller is configured to provide an output signal that causes the by-pass oxidant valve to decrease the amount of oxidant that is delivered through the by-pass oxidant supply pipe.

16. The process of claim 12, wherein the controller is configured to calculate a flow rate of the carbon dioxide stream through the carbon dioxide supply pipe based upon one or both of the following:
a combination of the output of the fuel flow rate signal and the output of the carbon dioxide flow rate signal;
a combination of the output of the carbon dioxide flow rate signal, the output of the oxidant flow rate signal, and the output of the by-pass oxidant flow rate signal.

17. The process of claim 12, wherein the turbine exhaust stream is passed through a heat exchanger to withdraw heat from the turbine exhaust stream and form a cooled turbine exhaust stream.

18. The process of claim 17, wherein heat withdrawn from the turbine exhaust stream is transferred to the carbon dioxide stream and to the first portion of the oxidant stream prior to passage of the carbon dioxide stream and the first portion of the oxidant stream into the combustor.

19. The process of claim 18, wherein the second portion of the oxidant stream in the by-pass oxidant supply pipe by-passes the heat exchanger.

20. The process of claim 17, further comprising removing water from the cooled turbine exhaust stream to form the carbon dioxide stream.

21. The process of claim 20, further comprising splitting the carbon dioxide stream and mixing a portion of the carbon dioxide stream with the first portion of the oxidant stream in the oxidant supply pipe to form a mixed gas stream in the oxidant supply pipe.

22. The process of claim 21, wherein the portion of the carbon dioxide stream is added directly to the oxidant supply pipe.

23. The process of claim 21, wherein the oxidant supply pipe includes a mixing part, and wherein the portion of the carbon dioxide stream is added to the mixing part.

24. A process for operation of a power generation plant, the process comprising:
providing a fuel stream, an oxidant stream, and a carbon dioxide stream to a combustor wherein fuel from the fuel stream is combusted with oxygen from the oxidant stream in the presence of the carbon dioxide to form a combustion exhaust gas;
rotating a turbine with the combustion exhaust gas to generate power and provide a turbine exhaust stream;
cooling the turbine exhaust stream in a heat exchanger to form a cooled turbine exhaust stream;
removing water from the cooled turbine exhaust stream to form the carbon dioxide stream;
compressing the carbon dioxide stream; and
recycling at least a portion of the carbon dioxide stream that has been compressed to the combustor by passage through the heat exchanger;
wherein the oxidant stream is split before being provided to the combustor so that a first portion of the oxidant stream passes through the heat exchanger and so that a second portion of the oxidant stream by-passes the heat exchanger and is recombined with the first portion of the oxidant stream downstream from the heat exchanger and upstream from the combustor.

25. The process of claim 24, further comprising providing an output signal from a fuel flow rate detecting unit, an output signal from an oxidant flow rate detecting unit, an output signal from a by-pass oxidant flow rate detecting unit, and an output signal from at least one carbon dioxide flow rate detecting unit to a control unit.

26. The process of claim 25, further comprising calculating in the control unit, based upon the received output signals, at least one of a required fuel flow rate, a required oxidant flow rate, a required by-pass oxidant flow rate, and a required carbon dioxide flow rate.

27. The process of claim 26, further comprising regulating flow of at least one of the fuel stream, the oxidant stream, the by-pass oxidant stream, and the carbon dioxide stream through a corresponding fuel flow regulating valve, oxidant flow regulating valve, by-pass oxidant flow regulating valve, and carbon dioxide flow regulating valve, respectively, so that one or more of the fuel stream, the oxidant stream, the by-pass oxidant stream, and the carbon dioxide stream is supplied in required amounts.
